(19) United States
(12) Patent Application Publication
(10) Pub. No.: US 2011/0191208 A1
(43) Pub. Date: Aug. 4, 2011

(54) Notary application services

(75) Inventor: Kevin A. Govin, Tampa, FL (US)

(73) Assignee: MarkMaster Inc., Tampa, FL (US)

(21) Appl. No.: 12/931,276

(22) Filed: Jan. 28, 2011

Related U.S. Application Data
(60) Provisional application No. 61/337,097, filed on Feb. 1, 2010.

(51) Int. Cl. G06Q 99/00; G06Q 30/00

(52) U.S. Cl. 705/26.41

(57) ABSTRACT

The unique part of our product is the invention of the all-in-one price packet, which includes all checks, fees, bonds, insurance and notary tools.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Notary Application Services process stems from a need for client associates to become legal notaries in a quick and easy approach. Many companies only offer partial elements needed to become a notary, such as applications, bonds or supplies. By using several different companies to fulfill the intention of becoming a notary, applicant's misuse valuable time and resources.

### SUMMARY OF THE INVENTION

The invented Notary Application Services is a compilation that includes each state's requirements, instructions, applications, checks, bonds, supplies and other items for a client associates and customers to become a notary. Unlike other companies who only supply applications, bonds or supplies, MarkMaster, Inc.'s Notary Application Services is all inclusive. Client associates can apply for and become a legal notary in any county/state in the United States using this process with their order-to-pay system. The general public can order our services through our DBA, Complete Notary. This process allows the applicant to receive all instructions, applications, checks, bonds, background searches, registrations and tools needed to become a legal notary in their state. The steps in the process guide the applicant from beginning to end of the application progression for one fee.

### BRIEF DESCRIPTION OF THE DRAWING

This is a process which is unique to each state. Attached is an entire packet for the state of California as an example.

The State of California notary packet includes the following:
Step by Step Instructions
Notary Application
LiveScan Application
Notary Stamp, Journal and Bond Voucher
Check for LiveScan (not included in example packet)
Check for Application Fee (not included in example packet)
Check for County Clerk (depending on county there may be 2 checks for the county)

### DETAILED DESCRIPTION

This process is an all inclusive service for corporations that allows their employees to become Notary Publics for a flat fee. Using their internal ordering system, associates are able to order the packages without having to pay out-of-pocket or burdening their accounting department with reimbursements. The general public can also order our services through our DBA, Complete Notary via our website, www.completenotary.net.

Once the associate or client places the order, they receive the notary packet via a track-able mail method. Their packet will include instructions, forms, address(es) for testing locations (if necessary), applications, checks, bonds and a voucher for their notary supplies. The associate will have to follow the instruction in sequential order for the process to work (i.e. Step 1 needs to be complete before moving on to the next step).

As in the case of the attached drawing, notary packet for California (Note—the following steps may and will vary per the county/state's requirements), the first step the associate needs to take after receiving the packet is to take a mandatory education course and there is a link providing all the approved locations for this training.

The next step is to register for notary public exam. Once registered for the exam via the provided website, the associate must fill out the notary application that was included in the packet. The packet includes a set of instructions so that the application is filled out properly. When taking the exam the associate needs to take with them the completed application, check(s)—provided in the packet, proof of the completed education course and a photograph.

The State of California requires that a Live Scan background check is completed once the associate has passed the notary exam. The associate must select and go to a LiveScan location from the list provided in packet, with their filled out supplied application and check. After the background check has come back with positive results the State will send the associate a packet in which they need to complete and send to us.

When we have received their original paperwork from the state we can issue a bond and send back to the associate. The associate will go to the County Clerk's office from the list provided and take with them the included check, bond, commission certificate, oath form and filing forms. In the meantime, the associate or customer has returned to us the notary supply voucher we supplied them along with a copy of their commission certificate. We then manufacture their personal notary stamp or seal and send this to the associate or customer along with a notary journal. Once they have received their stamp and journal from us they have officially become a notary public.

What is claimed is:

1. The MarkMaster, Inc. Notary Application Service is an all-inclusive process which allows client associates and customers to apply for a New Notary Commission or a Renewal Notary Commission in their state with one single order. Using their order-to-pay system, such as Ariba, Oracle, PeopleSoft and SAP, applicants can order a packet that is specific to their state (and county where applicable) which contains all provisions to become a notary. The general public can also purchase notary application kits through our DBA, Complete Notary via our website, www.completenotary.net.
Each packet is tailored to the specific requirements of the applicant's state (or county where applicable) and contains instructions for the application process, the application, and any checks necessary to complete the process, such as processing fees, LiveScan fingerprinting fees, Filing fees, notary education/training fees, etc. Unnecessary training, supplies or insurance is not offered.
Also included in the packet are any bonds required by the applicant's state. MarkMaster, Inc. is a licensed surety bond agency, which allows applicants whose state requires bonds for their notaries to pay for and receive the bond without having to go through a separate agency. All costs are grouped into one sum and paid for using the electronic order-to-pay system in which the applicant's company currently utilizes. No out-of-pocket reimbursements are necessary since all costs are covered in the price.
As a manufacturer of rubber stamp and regulation seals, MarkMaster, Inc. is able to include the notary tools necessary for each applicant promptly and at a greatly reduced cost. Notary tools include: a notary seal (rubber or embosser depending on regulations of each state), notary record journal, notary Errors & Omissions Insurance (where applicable), Acknowledgement forms (California only) and Jurat forms (California only).
